(19) United States
(12) Patent Application Publication
(10) Pub. No.: US 2005/0085391 A1
(43) Pub. Date: Apr. 21, 2005

(54) Aqueous plant-protection formulations

(76) Inventors: Gerd Roland Meyer, Frankfurt am Main (DE); Ralf Zerrer, Karlstein (DE); Roman Morschhaeuser, Mainz (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/500,025

(22) PCT Filed: Dec. 17, 2002
(86) PCT No.: PCT/EP02/14366

(30) Foreign Application Priority Data
Dec. 22, 2001 (DE) 10163887.6

(51) Int. Cl. A01N 25/10

(52) U.S. Cl. 504/361

(57) ABSTRACT

The invention relates to aqueous plant protection formulations comprising water-soluble pesticides, agrochemical salts and polymers based on acrylamidopropylmethylenesulfonic acid (AMPS) and “macromonomers”. The formulations show high solubility of the pesticides and of the agrochemical salts, and excellent stability on storage. The addition of the polymers improves the compatibility and solubility in water of the pesticides and agrochemical salts. Salting-out effects are suppressed or minimized. The formulations are preferably concentrated formulations, preferably soluble liquids (SL) and soluble concentrates.

The present invention relates to aqueous plant protection formulations comprising water-soluble pesticides, agrochemical salts and polymers based on acrylamidopropylmethylenesulfonic acid (AMPS) and “macromonomers”. The polymers improve the compatibility and water solubility of the pesticides and of the agrochemical salts. Salting-out effects are suppressed.

Plant protection formulations with a broad spectrum of activity comprising pesticides and fertilizers in only one formulation are acquiring increasing significance. The different physical/chemical properties of pesticides and fertilizers frequently result in the components being incompatible, which phenomenon is very noticeable in particular at high concentrations. Incompatibilities of this kind result in phase separations, crystallization processes and sedimentation processes. In addition, the high electrolyte content of the formulations brings about a strong salting-out effect, which de facto reduces the solubility of the components.

In the preparation of highly concentrated aqueous plant protection formulations, however, the solubilities of the pesticides and of the agrochemical salts are the determining factor. The most highly concentrated solutions possible without organic solvents are desired, which solutions are also subject to no phase separation, crystallization and sedimentation after a long storage time and large temperature variations.

It has now been found, surprisingly, that aqueous plant protection formulations comprising water-soluble pesticides, agrochemical salts and polymers based on acrylamidopropylmethylenesulfonic acid (AMPS) and “macromonomers” show high solubility of the pesticides and of the agrochemical salts and excellent stability on storage. The polymers improve the compatibility and solubility in water of the pesticides and agrochemical salts and act as solubilizers. Salting-out effects are suppressed or minimized. The formulations are preferably concentrated formulations, preferably soluble liquids (SL) and soluble concentrates.

The invention accordingly relates to aqueous plant protection formulations comprising
i) at least one polymer which can be prepared by radical copolymerization of
   A) acrylamidopropylmethylenesulfonic acid (AMPS) and/or its salts;
   B) one or more macromonomers comprising
      i) a terminal group which is capable of polymerizing and which is at least partially soluble in the reaction medium,
      ii) a hydrophobic part which is hydrogen or a saturated or unsaturated, linear or branched, aliphatic, cycloaliphatic or aromatic (C₁-C₁₀₀)-hydrocarbon residue, and
      iii) optionally a hydrophilic part based on polyalkylene oxides, and
   C) optionally one or more other at least mono- or polyolefinically unsaturated oxygen-, nitrogen-, sulfur-, phosphorus-, chlorine- and/or fluorine-comprising comonomers,
ii) at least one pesticide and
iii) at least one agrochemical salt.

The agrochemical salts iii) are not pesticides ii).

The macromonomers B) preferably comprise a hydrophilic part based on polyalkoxides, preferably polyethylene oxides and/or polypropylene oxides.

Suitable salts of acrylamidopropylmethylenesulfonic acid (AMPS) are preferably the lithium, sodium, potassium, magnesium, calcium, ammonium, monoalkylammonium, dialkylammonium, trialkylammonium or tetraalkylammonium salts, the alkyl substituents of the ammonium ions being, independently of one another, (C₁-C₂₂)-alkyl residues which can carry 0 to 3 hydroxyalkyl groups, the alkyl chain length of which can vary within a range from C₂ to C₁₀. Mono- to triethoxylated ammonium compounds with a variable degree of ethoxylation are likewise suitable.

The sodium and ammonium salts are particularly preferred as salts.

The degree of neutralization of the acrylamidopropylmethylenesulfonic acid (AMPS) is preferably 70 to 100 mol %.

The comonomer A) is preferably the sodium salt and/or ammonium salt of acrylamidopropylmethylenesulfonic acid (AMPS).

The macromonomers B) are preferably those of the formula (1)
R¹—Y—(R²—O)ₓ(R⁴—O)_{z}—R³ (1)
in which
R¹ is a vinyl, allyl, acryloyl (i.e. CH₂═CH—CO—), methacryloyl, (i.e. CH₂═C(CH₃)—CO—), senecioyl or crotonyl residue;
R² and R⁴ are, independently of one another, (C₂-C₄)-alkylene;
x and z are, independently of one another, an integer between 0 and 500, preferably with x+z greater than or equal to 1;
Y is O, S, PH or NH, preferably 0; and
R³ is hydrogen or a saturated or unsaturated, linear or branched, aliphatic, cycloaliphatic or aromatic (C₁-C₁₀₀)-hydrocarbon residue, preferably (C₁-C₃₀)-hydrocarbon residue.
R¹ is particularly preferably an acryloyl or methacryloyl residue.
R and R are particularly preferably a C₂- or C₃-alkylene residue.

Particularly preferably, x and z are, independently of one another, a number between 0 and 50, preferably with x+z greater than or equal to 1.

Especially preferably, 5≦x+z≦50 applies.
R³ is particularly preferably an aliphatic (C₄-C₂₂)-alkyl or -alkenyl residue, preferably (C₁₀-C₂₂)-alkyl or -alkenyl residue; a phenyl residue;
a (C₁-C₂₂)-alkylphenyl residue, preferably (C₁-C₉)-alkylphenyl residue, particularly preferably (C₁-C₄)-alkylphenyl residue, especially preferably sec-butyl- or n-butylphenyl residue;
a poly((C₁-C₂₂)-alkyl)phenyl residue, preferably poly((C₁-C₉)-alkyl)phenyl residue, particularly preferably poly((C₁-C₄)-alkyl)phenyl residue, especially preferably poly(sec-butyl)phenyl residue, very particularly preferably tris(sec-butyl)phenyl residue or tris(n-butyl)phenyl residue; or
a polystyrylphenyl residue [i.e. poly(phenylethyl)phenyl residue], particularly preferably tristyrylphenyl residue [i.e. tris(phenylethyl)phenyl residue].

Preference is especially given, as R residues, to 2,4,6-tris(1-phenylethyl)-phenyl residues and 2,4,6-tris(sec-butyl)phenyl residues.

The macromonomers B) are preferably prepared by reaction of reactive derivatives of unsaturated carboxylic acids, preferably of methacrylic or acrylic acid, with the corresponding, optionally alkoxylated, alkyl or aryl residues comprising hydroxyl groups. The ring-opening addition to the respective carboxylic acid glycidyl esters is also possible.

In a preferred embodiment, the polymers comprise still other olefinically unsaturated oxygen-, nitrogen-, sulfur-, phosphorus-, chlorine- and/or fluorine-comprising comonomers C).

Preference is given, as comonomers C), to olefinically unsaturated acids or their salts, preferably with mono- and divalent counterions, particularly preferably styrenesulfonic acid, vinylsulfonic acid, vinylphosphonic acid, allylsulfonic acid, methallylsulfonic acid, acrylic acid, methacrylic acid and/or maleic acid or maleic anhydride, fumaric acid, crotonic acid, itaconic acid or senecioic acid or their salts. Preferred counterions are Li⁺, Na⁺, K⁺, Mg²⁺, Ca²⁺, Al³⁺, NH₄⁺, monoalkylammonium, dialkylammonium, trialkylammonium and tetraalkylammonium ions, in which the substituents of the amines are, independently of one another, (C₁-C₂₂)-alkyl residues which can carry 0 to 3 hydroxyalkyl groups, the alkyl chain length of which can vary within the range from C₂ to C₁₀. In addition, mono- to triethoxylated ammonium compounds with a variable degree of ethoxylation, and corresponding acid anhydrides (also mixed), can also be used. The degree of neutralization of the optional olefinically unsaturated acids C) can be 0 to 100 mol %, preferably 70 to 100 mol %.

Also suitable as comonomers C) are esters of unsaturated carboxylic acids, preferably acrylic acid, methacrylic acid, styrenesulfonic acid, maleic acid, fumaric acid, crotonic acid and senecioic acid, with aliphatic, aromatic or cycloaliphatic alcohols with a carbon number of 1 to 30.

Suitable comonomers C) are likewise acyclic and cyclic N-vinylamides (N-vinyllactams) with a ring size of 4 to 9 atoms, preferably N-vinylformamide (NVF), N-vinylmethylformamide, N-vinylmethylacetamide (VIMA), N-vinylacetamide, N-vinylpyrrolidone (NVP), N-vinylcaprolactam; amides of acrylic acid and of methacrylic acid, particularly preferably acrylamide, N,N-dimethylacrylamide, N,N-diethylacrylamide, N,N-diisopropylacrylamide; alkoxylated acrylamides and methacrylamides, preferably hydroxymethylmethacrylamide, hydroxyethylmethacrylamide and hydroxypropylmethacrylamide.

Likewise suitable are succinic acid mono[2-(methacryloyloxy)ethyl ester]; N,N-dimethylamino methacrylate; diethylaminomethyl methacrylate; acryl- and methacrylamidoglycblic acid; [2-(methacryloyloxy)ethyl]trimethylammonium chloride (MAPTAC) and [2-(acryloyloxy)ethyl]trimethylammonium chloride (APTAC); 2-vinylpyridine; 4-vinylpyridine; vinyl acetate; methacrylic acid glycidyl ester; acrylonitrile; vinyl chloride; vinylidene chloride; tetrafluoroethylene; diallyldimethylammonium chloride (DADMAC); stearyl acrylate; and/or lauryl methacrylate.

Also suitable are methylenebisacrylamide and methylenebismethacrylamide; esters of unsaturated mono- and polycarboxylic acids with polyols, e.g. diacrylates or triacrylates, such as butanediol diacrylate or dimethacrylate, ethylene glycol diacrylate or dimethacrylate, and trimethylolpropane triacrylate; allyl compounds, e.g. allyl (meth)acrylate, triallyl cyanurate, maleic acid diallyl ester, polyallyl esters, tetraallyloxyethane, triallylamine, tetraallylethylenediamine, allyl esters of phosphoric acid; and/or vinylphosphonic acid derivatives.

Preference is particularly given, for use, to polymers which can be prepared by radical copolymerization of
A) acrylamidopropylmethylenesulfonic acid (AMPS), the sodium salt of acrylamidopropylmethylenesulfonic acid (AMPS) and/or the ammonium salt of acrylamidopropylmethylenesulfonic acid, preferably the ammonium salt of acrylamidopropylmethylenesulfonic acid (AMPS);
B) one or more macromonomers chosen from the group of the esters formed from methacrylic acid or acrylic acid, preferably methacrylic acid, and compounds of the formula (2)
   HO—(CH₂—CH₂—O)ₓ—R³ (2)
   in which x is a number between 0 and 50, preferably 1 and 50, particularly preferably 5 and 30, and
   R³ is a (C₁₀-C₂₂)-alkyl residue; and
C) optionally one or more comonomers chosen from the group consisting of acrylamide, vinylformamide, N-vinylmethylacetamide, sodium methallylsulfonate, hydroxyethyl methacrylate, acrylic acid, methacrylic acid, maleic anhydride, methacrylamide, vinyl acetate, N-vinylpyrrolidone, vinylphosphonic acid, styrene, styrenesulfonic acid (Na salt), t-butyl acrylate and methyl methacrylate, preferably methacrylic acid and/or methacrylamide.

Macromonomers B) which are especially suitable are esters formed from acrylic acid or methacrylic acid and alkyl ethoxylates chosen from the group consisting of
(C₁₀-C₁₈)-fatty alcohol polyglycol ethers with 8 EO units (Genapol® C-080);
C₁₁-oxo alcohol polyglycol ethers with 8 EO units (Genapol® UD-080);
(C₁₂-C₁₄)-fatty alcohol polyglycol ethers with 7 EO units. (Genapol® LA-070);
(C₁₂-C₁₄)-fatty alcohol polyglycol ethers with 11 EO units (Genapol® LA-110);
(C₁₆-C₁₈)-fatty alcohol polyglycol ethers with 8 EO units (Genapol® T-080);
(C₁₆-C₁₈)-fatty alcohol polyglycol ethers with 15 EO units (Genapol® T-150);
(C₁₆-C₁₈)-fatty alcohol polyglycol ethers with 11 EO units (Genapole T-110);
(C₁₆-C₁₈)-fatty alcohol polyglycol ethers with 20 EO units (Genapole T-200);
(C₁₆-C₁₈)-fatty alcohol polyglycol ethers with 25 EO units (Genapol® T-250);
(C₁₈-C₂₂)-fatty alcohol polyglycol ethers with 25 EO units;
iso(C₁₆-C₁₈)-fatty alcohol polyglycol ethers with 25 EO units; and
C₂₂-fatty alcohol polyglycol ethers with 25 EO units (Mergital® B-25).

In this connection, the EO units are ethylene oxide units. The Genapol® grades are products from Clariant, and Mergital® B25 is a product from Cognis.

Particular preference is likewise given, for use, to polymers which can be prepared by radical copolymerization of
A) acrylamidopropylmethylenesulfonic acid (AMPS), the sodium salt of acrylamidopropylmethylenesulfonic acid (AMPS) and/or the ammonium salt of acrylamidopropylmethylenesulfonic acid, preferably the ammonium salt of acrylamidopropylmethylenesulfonic acid (AMPS);
B) one or more macromonomers chosen from the group of the esters formed from acrylic acid or methacrylic acid, preferably methacrylic acid, and compounds of the formula (3)
   HO—(CH₂—CH₂—O)ₓ—R³ (3)
   in which
   x is a number between 0 and 50, preferably 1 and 50, particularly preferably 5 and 30, and
   R³ is a poly((C₁₀-C₂₂)-alkyl)phenyl residue, preferably tris(sec-butyl)phenyl residue or tris(n-butyl)phenyl residue, particularly preferably 2,4,6-tris(sec-butyl)phenyl residue, or a tris(styryl)phenyl residue, preferably 2,4,6-tris(1-phenylethyl)phenyl residue; and
C) optionally one or more comonomers chosen from acrylamide, vinylformamide, N-vinylmethylacetamide, sodium methallylsulfonate, hydroxyethyl methacrylate, acrylic acid, methacrylic acid, maleic anhydride, methacrylamide, vinyl acetate, N-vinylpyrrolidone, vinylphosphonic acid, styrene, styrenesulfonic acid (Na salt), t-butyl acrylate and methyl methacrylate, preferably methacrylic acid and/or methacrylamide.

The proportion by weight of the macromonomers B) in the polymer can vary between 0.1 and 99.9% by weight.

In a preferred embodiment, the polymers are highly hydrophobically modified, i.e. the proportion of macromonomers B) is 50.1 to 99.9% by weight, preferably 70 to 95% by weight, particularly preferably 80 to 94% by weight.

In another preferred embodiment, the polymers are poorly hydrophobically modified, i.e. the proportion of macromonomers B) is 0.1 to 50% by weight, preferably 5 to 25% by weight, particularly preferably 6 to 20% by weight.

The monomer distribution of the monomers A), B) and C) in the polymers can be alternating, random, gradient or block (also multiblock). The number-average molecular weight of the polymers is preferably 1000 to 20 000 000 g/mol, preferably 20 000 to 5 000 000 g/mol, particularly preferably 50 000 to 1 500 000 g/mol.

In a preferred embodiment, the polymers are crosslinked, i.e. at least one crosslinking agent with at least two double bonds is copolymerized in the polymer.

Preferred crosslinking agents are methylenebisacrylamide and methylenebismethacrylamide; esters of unsaturated mono- or polycarboxylic acids with polyols, preferably diacrylates and triacrylates, e.g. butanediol diacrylate or dimethacrylate, ethylene glycol diacrylate or dimethacrylate, and trimethylolpropane triacrylate, allyl compounds, preferably allyl (meth)acrylate, triallyl cyanurate, maleic acid diallyl ester, polyallyl esters, tetraallyloxyethane, triallylamine, tetraallylethylenediamine, allyl esters of phosphoric acid; and/or vinylphosphonic acid derivatives.

The polymers can be prepared by radical copolymerization, e.g. precipitation polymerization, emulsion polymerization, solution polymerization or suspension polymerization.

Particularly suitable are polymers which were prepared by precipitation polymerization, preferably in tert-butanol.

Using precipitation polymerization in tert-butanol, a specific particle size distribution of the polymers can be obtained in comparison with other solvents. The size distribution of the polymer particle can, e.g., be determined by laser diffraction or sieve analysis. The following particle size distribution is representative of a convenient size distribution, the particle size distribution having been determined by sieve analysis: 60.2% less than 423 micrometers, 52.0% less than 212 micrometers, 26.6% less than 106 micrometers, 2.6% less than 45 micrometers and 26.6% greater than 850 micrometers.

The polymerization reaction can be carried out in the temperature range between 0 and 150° C., preferably between 10 and 100° C., both at standard pressure and under increased or reduced pressure. As usual, the polymerization can also be carried out in a protective gas atmosphere, preferably under nitrogen.

The polymerization can be initiated by high-energy electromagnetic radiation or the usual chemical polymerization initiators, e.g. organic peroxides, such as benzoyl peroxide, tert-butyl hydroperoxide, methyl ethyl ketone peroxide or cumene hydroperoxide, azo compounds, such as, e.g., azobisisobutyronitrile or azobisdimethylvaleronitrile, and inorganic peroxy compounds, such as, e.g., (NH₄)₂S₂O₈, K₂S₂O₈ or H₂O₂, optionally in combination with reducing agents, such as, e.g., sodium hydrogensulfite and iron(II) sulfate, or redox systems comprising, as reducing component, an aliphatic or aromatic sulfonic acid, such as, e.g., benzenesulfonic acid, toluenesulfonic acid or derivatives of these acids, such as, e.g., Mannich adducts from sulfinic acid, aldehydes and amino compounds.

The polymers are readily soluble in water and are thermally stable. The salting-out effects of the salt components can be minimized and the rheological properties of the solutions can be adjusted by the choice of the monomers with their functional groups, of the monomer distribution and of the degree of crosslinking.

The proportion of polymers in the formulations is, based on the ready-mix formulations, preferably 0.01 to 10% by weight, particularly preferably 0.01 to 5% by weight, especially preferably 0.01 to 2.5% by weight.

The proportion of water in the formulations is, based on the ready-mix formulations, preferably 5 to 60% by weight, particularly preferably 5 to 50% by weight.

The invention is particularly suitable for highly concentrated solutions with a proportion of water of 5 to 30% by weight.

Suitable pesticides are herbicides, insecticides, fungicides, acaricides, bactericides, molluscicides, nematicides and/or rodenticides.

The pesticides are preferably water-soluble pesticides. The term “water-soluble pesticides” is to be understood as meaning those which have a solubility in water, based on the pure aqueous solution, of greater than 800 g/l, preferably greater than 1000 g/l.

Use is preferably made of ionogenic pesticides, particularly preferably glyphosate, sulfosate and glufosinate, especially preferably glyphosate in the form of its mono(isopropylammonium) salt or mono(trimethylsulfonium) salt.

The proportion of pesticides in the formulations is, based on the ready-mix formulations, preferably 5-85% by weight, particularly preferably 25 to 60% by weight, especially preferably 25 to 50% by weight.

The agrochemical salts are preferably inorganic fertilizers, preferably ammonium salts, particularly preferably ammonium sulfate, nitrates, preferably ammonium nitrate, and/or phosphates.

The proportion of agrochemical salts is, based on ready-mix formulations, preferably 5 to 85% by weight, particularly preferably 25 to 60% by weight, especially preferably 25 to 50% by weight.

Auxiliaries/additives which can be present in the formulations include, inter alia, surface-active agents (adjuvants), antifoam agents, thickeners, antifreeze agents, evaporation retardants, preservatives, antigelling agents and neutralizing agents.

The proportion of surface-active agents is, based on the ready-mix formulations, preferably 5 to 50% by weight, particularly preferably 15 to 40% by weight.

Suitable surface-active agents are preferably addition products of 2 to 30 mol of ethylene oxide and/or 0 to 5 mol of propylene oxide with linear fatty alcohols with 8 to 22 carbon atoms, with fatty acids with 12 to 22 carbon atoms, with mono-, di- and/or trialkylphenols with 8 to 15 carbon atoms in the alkyl group and with (C₈-C₁₈)-alkylamines; secondary ether amines and alkoxylated secondary ether amine derivatives; (C₁₂-C₁₈)-fatty acid mono- and diesters of addition products of 1 to 30 mol of ethylene oxide with glycerol; glycerol mono- and diesters and sorbitan/sorbitol mono- and diesters of saturated and unsaturated fatty acids with 6 to 22 carbon atoms and their ethylene oxide addition products; addition products of 15 to 60 mol of ethylene oxide with castor oil and/or hydrogenated castor oil; polyol and in particular polyglycerol esters, e.g. polyglycerol polyricinoleate and polyglycerol poly(12-hydroxystearate); carboxamides, e.g. decanoic acid dimethylamide; high-molecular-weight silicone compounds, e.g. dimethylpolysiloxanes with an average molecular weight of 10 000 to 50 000 g/mol.

Also suitable are anionic surfactants, e.g. alkali metal and ammonium salts of linear or branched alkyl(ene) sulfates with 8 to 22 carbon atoms, (C₁₂-C₁₈)-alkylsulfonic acids and (C₁₂-C₁₈)-alkylarylsulfonic acids; bis(phenolsulfonic acid) ethers and their alkali metal or ammonium salts, isethionates, preferably cocoyl isethionate; naphthalenesulfonic acid and/or sulfosuccinates.

Preferred antifoam agents are fatty acid alkyl ester alkoxylates; organopolysiloxanes and their mixtures with microfine, optionally, silanized silicic acid; paraffins; waxes and microcrystalline waxes and their mixtures with silanized silicic acid. Mixtures of different antifoam agents, e.g. those from silicone oil, paraffin oil and/or waxes, are also advantageous. The antifoam agents are preferably bound to a granular carrier which is soluble or dispersible in water.

Thickening agents which are preferably used are hydrogenated castor oil; salts of long-chain fatty acids, preferably in amounts of up to 5% by weight, particularly preferably in amounts of 0.5 to 2% by weight, e.g. sodium, potassium, aluminum, magnesium and titanium stearates or the sodium and/or potassium salts of behenic acid; polysaccharides, especially xanthan gum, guar, agar, alginates and Tyloses; carboxymethylcellulose and hydroxyethylcellulose; high-molecular-weight polyethylene glycol mono- and diesters of fatty acids; polyacrylates; polyvinyl alcohol and/or polyvinylpyrrolidone.

Suitable preservatives are, for example, phenoxyethanol, formaldehyde solution, parabens, pentanediol or sorbic acid.

The formulations are preferably adjusted to a pH in the range 2 to 12, particularly preferably 3 to 8, especially preferably 6.5 to 7.5.

It has also been found, surprisingly, that the formulations can be free of organic solvents, such as, e.g., xylene or (C₆-C₁₆)-aromatic hydrocarbon mixtures (e.g. Solvesso® grades).

The formulations are preferably soluble liquids (SL) or soluble concentrates.

The use of the polymers provides the user with a large degree of freedom in the choice of his components. The formulations show high compatibility of the components with one another (pesticides, salts, adjuvants, and the like), high solubility of the pesticides and agrochemical salts, and excellent stability on storage. The polymers act as solubilizers. Salting-out effects are suppressed or minimized.

### EXAMPLE 1

### Preparation of Polymer 1

500 g of toluene were introduced into a 1 l Quickfit flask equipped with a stirrer, an internal thermometer, gas inlet pipes for nitrogen and ammonia gas, and a reflux condenser. Furthermore, 3.0 g of 2-acrylamio-2-methylpropanesulfonic acid (AMPS) were introduced and were neutralized with the equivalent amount of ammonia. Subsequently, 60.0 g of an ester, formed from acrylic acid and (C₁₂-C₁₄)-fatty alcohol polyglycol ethers with 7 ethylene oxide units (Genapol® LA-070), and 30.0 g of isopropanol were added. The contents of the flask were rendered inert with nitrogen while stirring and were heated to 70° C. using a heating bath. After reaching the temperature, 3.0 g of AIBN were added as initiator and the contents of the flask were heated to 80° C. while continuing to flush with nitrogen. The mixture was stirred at reflux at the stated temperature for 4 h. After the reaction was complete, the product was transferred to a rotary evaporator and the solvent was removed by vacuum distillation at approximately 50° C.

### EXAMPLE 2

### Preparation of Polymer 2

Analogous procedure to example 1; furthermore, 1.0 g of trimethylolpropane triacrylate (TMPTA) was added for crosslinking.

### EXAMPLE 3

### Soluble Liquid Formulation (SL) Without Polymer

Composition:

| | |
|---|---|
| Ammonium sulfate, techn. | 40% by weight |
| Arkopal ® N 100 (nonylphenol ethoxylate | 30% by weight |
| with 10 EO units) | |
| Glyphosate IPA (62% by weight aq. sol.) | 30% by weight |

On mixing together the components, phase separation spontaneously occurred.

### EXAMPLE 4

### Soluble Liquid Formulation (SL) with Polymer

Composition:

| | |
|---|---|
| Ammonium sulfate, techn. | 40% by weight |
| Arkopal ® N 100 (nonylphenol ethoxylate | 28% by weight |
| with 10 EO units) | |
| Glyphosate IPA (62% by weight aq. sol.) | 30% by weight |
| Polymer 1 from ex. 1 | 2% by weight |

On mixing together, a clear homogeneous solution was formed which also remained stable over a relatively long period of time.

1. An aqueous plant protection formulation comprising
i) at least one polymer prepared by radical copolymerization of
A) acrylamidopropylmethylenesulfonic acid (AMPS) and/or its salts;
B) one or more macromonomers according to formula (1)
R¹—Y—(R²—O)ₓ(R⁴—O)_{z}—R³ (1)
in which
R¹ is a vinyl, allyl, acryloyl, methacryloyl, senecioyl or crotonyl residue;
R² and R⁴ are, independently of one another, (C₂-C₄)-alkylene;
x and z are, independently of one another, an integer between 0 and 500, with x+z greater than or equal to 1;
Y is O, S, PH or NH; and
R³ is hydrogen or a saturated or unsaturated, linear or branched, aliphatic, cycloaliphatic or aromatic (C₁-C₁₀₀)-hydrocarbon residue, and
c) optionally one or more other at least mono- or polyolefinically unsaturated oxygen-, nitrogen-, sulfur-, phosphorus-, chlorine- and/or fluorine containing comonomers,
ii) at least one pesticide and
iii) at least one inorganic fertilizer.

2. A plant protection formulation as claimed in claim 1, wherein the comonomer A) is the sodium salt and/or ammonium salt of acrylamidopropylmethylenesulfonic acid (AMPS).

3. A plant protection formulation as claimed in claim 1, wherein
R¹ is an acryloyl or methacryloyl residue;
R² and R⁴ are, independently of one another, C₂-alkylene or C₃-alkylene;
x and z are, independently of one another, an integer between 0 and 50, with x+z greater than or equal to 1;
R³ is an aliphatic (C₄-C₂₂)-alkyl or -alkenyl residue;
a phenyl residue;
a (C₁-C₂₂)-alkylphenyl residue;
a poly((C₁-C₂₂)-alkyl)phenyl residue; or
a polystyrylphenyl residue.

4. A plant protection formulation as claimed in claim 3, wherein the R³ residue is a 2,4,6-tris(sec-butyl)phenyl residue or 2,4,6-tris(1-phenylethyl)phenyl residue.

5. A plant protection formulation as claimed in claim 1, wherein the at least one polymer is prepared by radical copolymerization of
A) acrylamidopropylmethylenesulfonic acid (AMPS), the sodium salt of acrylamidopropylmethylenesulfonic acid (AMPS) and/or the ammonium salt of acrylamidopropylmethylenesulfonic acid;
B) one or more macromonomers selected from the group consisting of esters formed from methacrylic acid or acrylic acid and compounds of the formula (2)
HO—(CH₂—CH₂—O)ₓ—R³ (2)
wherein x is a number between 1 and 50, and R³ is a (C₁₀-C₂₂)-alkyl residue; and
C) optionally one or more comonomers selected from the group consisting of acrylamide, vinylformamide, N-vinylmethylacetamide, sodium methallylsulfonate, hydroxyethyl methacrylate, acrylic acid, methacrylic acid, maleic anhydride, methacrylamide, vinyl acetate, N-vinylpyrrolidone, vinylphosphonic acid, styrene, styrenesulfonic acid (Na salt), t-butyl acrylate and methyl methacrylate.

6. A plant protection formulation as claimed in claim 1, wherein the one or more macromonomers B) are selected from the group consisting of esters formed from acrylic acid or methacrylic acid and alkyl ethoxylates selected from the group consisting of (C₁₀-C₁₈)-fatty alcohol polyglycol ethers with 8 EO units, C₁₁-oxo alcohol polyglycol ethers with 8 EO units, (C₁₂-C₁₄)-fatty alcohol polyglycol ethers with 7 EO units, (C₁₂-C₁₄)-fatty alcohol polyglycol ethers with 11 EO units, (C₁₆-C₁₈)-fatty alcohol polyglycol ethers with 8 EO units, (C₁₆-C₁₈)-fatty alcohol polyglycol ethers with 15 EO units, (C₁₆-C₁₈)-fatty alcohol polyglycol ethers with 11 EO units, (C₁₆-C₁₈)-fatty alcohol polyglycol ethers with 20 EO units, (C₁₆-C₁₈)-fatty alcohol polyglycol ethers with 25 EO units, (C₁₈-C₂₂)-fatty alcohol polyglycol ethers with 25 EO units, iso(C₁₆-C₁₈)-fatty alcohol polyglycol ethers with 25 EO units and/or and C₂₂-fatty alcohol polyglycol ethers with 25 EO units.

7. A plant protection formulation as claimed in claim 1, wherein the at least one polymer is prepared by radical copolymerization of
A) acrylamidopropylmethylenesulfonic acid (AMPS), the sodium salt of acrylamidopropylmethylenesulfonic acid (AMPS) and/or the ammonium salt of acrylamidopropylmethylenesulfonic acid;
B) one or more macromonomers selected from the group consisting of esters formed from methacrylic acid or acrylic acid and compounds of the formula (3)
HO—(CH₂—CH₂—O)ₓ—R³ (3)
wherein
x is a number between 1 and 50, particularly preferably 5 and 30, and
R³ is a poly((C₁-C₂₂)-alkyl)phenyl residue; and
C) optionally one or more comonomers selected from the group consisting of acrylamide, vinylformamide, N-vinylmethylacetamide, sodium methallylsulfonate, hydroxyethyl methacrylate, acrylic acid, methacrylic acid, maleic anhydride, methacrylamide, vinyl acetate, N-vinylpyrrolidone, vinylphosphonic acid, styrene, styrenesulfonic acid (Na salt), t-butyl acrylate and methyl methacrylate.

8. A plant protection formulation as claimed in claim 1, wherein the proportion of the one or more macromonomers B) in the at least one polymer is 50.1 to 99.9% by weight.

9. A plant protection formulation as claimed in claim 1, wherein the proportion of the one or more macromonomers B) in the at least one polymer is 0.1 to 50% by weight.

10. A plant protection formulation as claimed in claim 1, wherein the number-average molecular weight of the at least one polymer is 1000 to 20 000 000 g/mol.

11. A plant protection formulation as claimed in claim 1, wherein the at least one polymer is crosslinked.

12. A plant protection formulation as claimed in claim 1, wherein the radical copolymerization is a precipitation polymerization reaction.

13. A plant protection formulation as claimed in claim 1, comprising, based on a ready-mix formulation, 0.01 to 10% by weight of the at least one polymer.

14. A plant protection formulation as claimed in claim 1, further comprising water and wherein the water content, based on a ready-mix formulation, is 5 to 60% by weight.

15. A plant protection formulation as claimed in claim 1, wherein the solubility in water of the at least one pesticide is greater than 800 g/l, preferably greater than 1000 g/l.

16. A plant protection formulation as claimed in claim 1, wherein the at least one pesticide is an ionogenic pesticide.

17. A plant protection formulation as claimed in claim 1, wherein the at least one pesticide is glyphosate, sulphosate or glufosinate.

18. A plant protection formulation as claimed in claim 1, wherein the proportion of the at least one pesticide, based on a ready-mix formulation, is 5 to 85% by weight.

19. A plant protection formulation as claimed in claim 1, wherein the at least one inorganic fertilizer is an ammonium salt or a phosphate.

20. A plant protection formulation as claimed in claim 1, wherein the proportion of the at least one inorganic fertilizer, based on a ready-mix formulation, is 5 to 85% by weight.

21. A plant protection formulation as claimed in claim 1, wherein the plant protection formulation is free of organic solvents.

22. A plant protection formulation as claimed in claim 1, wherein the plant protection formulation is a soluble liquid (SL) or a soluble concentrate.

23. A plant protection formulation as claimed in claim 1, wherein 5≦x+z≦50.

24. A plant protection formulation as claimed in claim 1, wherein Y is oxygen.

25. A plant protection formulation as claimed in claim 1, wherein R³ is a (C₁-C₃₀)-hydrocarbon residue.

26. A plant protection formulation as claimed in claim 3, wherein R³ is a (C₁₀-C₂₂)-alkyl or -alkenyl residue.

27. A plant protection formulation as claimed in claim 3, wherein R³ is a sec-butyl- or n-butylphenyl residue.

28. A plant protection formulation as claimed in claim 3, wherein R³ is a tris(sec-butyl)phenyl residue or tris(n-butyl)phenyl residue.

29. A plant protection formulation as claimed in claim 3, wherein R³ is a tristyrylphenyl residue.

30. A plant protection formulation as claimed in claim 5, wherein the comonomer A) is the ammonium salt of acrylamidopropylmethylenesulfonic acid.

31. A plant protection formulation as claimed in claim 5, wherein the one or more macromonomers B) is an ester formed from methacrylic acid.

32. A plant protection formulation as claimed in claim 5, wherein x is between 5 and 30.

33. A plant protection formulation as claimed in claim 7, wherein the comonomer A) is the ammonium salt of acrylamidopropylmethylenesulfonic acid.

34. A plant protection formulation as claimed in claim 7, wherein the one or more macromonomers is an ester formed from methacrylic acid.

35. A plant protection formulation as claimed in claim 7, wherein x is between 5 and 30.

36. A plant protection formulation as claimed in claim 7, wherein R³ is a tris(sec-butyl)phenyl residue or tris(n-butyl)phenyl residue.

37. A plant protection formulation as claimed in claim 7, wherein R³ is a 2,4,6-tris(sec-butyl)phenyl residue.

38. A plant protection formulation as claimed in claim 7, wherein R³ is a 2,4,6-tris(1-phenylethyl)phenyl residue.

39. A plant protection formulation as claimed in claim 1, wherein the proportion of the one or macromonomers B) in the at least one polymer is 70 to 95% by weight.

40. A plant protection formulation as claimed in claim 1, wherein the proportion of the one or more macromonomers B) in the at least one polymer is 80 to 94% by weight.

41. A plant protection formulation as claimed claim 1, wherein the proportion of the one or more macromonomers B) in the at least one polymer is 5 to 25%.

42. A plant protection formulation as claimed claim 1, wherein the proportion of one or more macromonomers B) in the at least one polymer is 6 to 20%.

43. A plant protection formulation as claimed in claim 1, wherein the number-average molecular weight of the at least one polymer is 20 000 to 5 000 000 g/mol.

44. A plant protection formulation as claimed in claim 1, wherein the number-average molecular weight of the at least one polymer is 50 000 to 1 500 000 g/mol.

45. A plant protection formulation as claimed in claim 12, wherein the precipitation polymerization reaction occurs in tert-butanol.

46. A plant protection formulation as claimed in claim 1, comprising, based on a ready mixed formulation, 0.01 to 5% by weight of the at least one polymer.

47. A plant protection formulation as claimed in claim 1, further comprising water and wherein the water content, based on a ready-mix formulation, is 5 to 50% by weight.

48. A plant protection formulation as claimed in claim 1, further comprising water and wherein the water content, based on a ready-mix formulation, is 5 to 30% by weight.

49. A plant protection formulation as claimed in claim 1, wherein the solubility in water of the at least one pesticide is greater than 1000 g/l.

50. A plant protection formulation as claimed in claim 1, wherein the at least one pesticide, based on a ready-mix formulation is 25 to 60% by weight.

51. A plant protection formulation as claimed in claim 1, wherein the at least one inorganic fertilizer, based on a ready-mix formulation, is 25 to 60% by weight.
